(19) United States
(12) Patent Application Publication
(10) Pub. No.: US 2013/0172084 A1
(43) Pub. Date: Jul. 4, 2013

(54) DYNAMIC PEER-TO-PEER MAP RECONCILIATION IN A MULTIPLAYER GAMING ENVIRONMENT

(71) Applicants: Gary D. Cudak, Creedmor, NC (US); Christopher J. Hardee, Raleigh, NC (US); Randall C. Humes, Raleigh, NC (US); Adam Roberts, Moncure, NC (US)

(72) Inventors: Gary D. Cudak, Creedmor, NC (US); Christopher J. Hardee, Raleigh, NC (US); Randall C. Humes, Raleigh, NC (US); Adam Roberts, Moncure, NC (US)

(73) Assignee: International Business Machines Corporation, Armonk, NY (US)

(21) Appl. No.: 13/339,873

(22) Filed: Dec. 29, 2011

(51) Int. Cl. A63F 13/00

(52) U.S. Cl. 463/42

(57) ABSTRACT

A multiplayer game data processing system includes a computer coupled to a host server over a network and a game client executing in the computer and providing a user interface to a map of a virtual world provided by a game server hosted by the host server. The system additionally includes a map generator generating a portion of the map according to a corresponding contemporaneous position of a game player in the virtual world. Finally, the system includes a peer-to-peer map reconciliation module. The module includes program code enabled to detect movement of the game player to a new position in the virtual world in proximity to a bordering map generated by a different game player and to generate a new portion of the map for the new position of the game player that is consistent with a portion of the bordering map in respect to both structure and terrain.

### BACKGROUND OF THE INVENTION

1. Field of the Invention

The present invention relates to multiplayer gaming and more particularly to map generation in a multiplayer gaming environment.

2. Description of the Related Art

A multiplayer video game is one which multiple players can concurrently play a game within the same gaming environment. While single player games which have dominated computer gaming pit a single player against one or more automated opponents engaging in pre-programmatic behavior, multiplayer games pit different individuals against one another, each being limited to dynamic, on the fly behavior limited by the power of human thinking. Multi-player games also often provide a game environment in which different players engage in allied competition against other players whether human or computer automated. In the latter instance, cooperative multiplayer gaming environments reflect a 21st century version of the role playing board games of the 20th century.

Technologically, multiplayer gaming environments can be supported within a single gaming console, or in a distributed fashion over a computer communications network. In fact, some relatively recent multiplayer gaming environments are supported by geographically remote players communicatively connected to one another over the Internet through gaming consoles, personal computers, smart phone, personal digital assistants, or any combination thereof. However, in all instances, the virtual world in which the multiple players interact must remain consistent for all players. Thus, a mapping of the virtual world remains of paramount importance in a multiplayer gaming environment.

Many multiplayer gaming environments provide for static mapping of the virtual world in which a mapping of the virtual world is pre-stored and portions of the mapping are retrieved for use by different players when required. Thus, over time, a persistent gamer can become familiar with the mapping so as to gain an unfair advantage over less familiar gamers and ultimately, reduce the challenge experienced by the persistent gamer resulting in boredom. Thus, to provide for a consistent gaming challenge, the static maps can be changed over time by the developer of the multiplayer gaming environment. Yet, the need to provide new static maps periodically also increases the initial and long-term development costs for new games.

Other multiplayer gaming environments provide for dynamic mapping of the virtual world in which a relevant portion of the virtual world is generated in real time or near real time. As such, a gamer no matter how seasoned can lack familiarity with the mapping of the virtual world. The computer processing required to generate the dynamic mapping and the network latencies resulting from distributing the dynamically generated mapping to different players over the Internet, however, is significant and can result in delays to the start of each game. Finally, both static and dynamic mapping methods do not permit any form of real-time adjustment, when necessary.

### BRIEF SUMMARY OF THE INVENTION

Embodiments of the present invention address deficiencies of the art in respect to multiplayer gaming and provide a novel and non-obvious method, system and computer program product for dynamic peer-to-peer map reconciliation in a multiplayer gaming environment. In an embodiment of the invention, a dynamic peer-to-peer map reconciliation method for multiplayer gaming has been provided. The method includes generating a portion of a map in memory of a computer for a contemporaneous position of a first game player in a virtual world in a multiplayer gaming environment. The method also includes displaying the portion of the map in a display of the computer. The method yet further includes detecting movement of the first game player to a new position in the virtual world in proximity to a bordering map generated by a second game player in memory of a computer communicatively coupled to the computer of the first game player over a computer communications network. Finally, the method includes generating and displaying in the computer of the first game player a new portion of the map for the new position of the first game player that is consistent with a portion of the bordering map in respect to both structure and terrain.

In another embodiment of the invention, a multiplayer game data processing system has been provided. The system includes a computer with at least one processor and memory coupled to a host server over a computer communications network and a game client executing in the computer and providing a user interface to a map of a virtual world provided by a game server hosted by the host server. The system additionally includes a map generator executing in the computer and generating a portion of the map according to a corresponding contemporaneous position of a game player in the virtual world. Finally, the system includes a peer-to-peer map reconciliation module coupled to the map generator. The module includes program code enabled to detect movement of the game player to a new position in the virtual world in proximity to a bordering map generated by a different game player and to generate a new portion of the map for the new position of the game player that is consistent with a portion of the bordering map in respect to both structure and terrain.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for dynamic peer-to-peer map reconciliation in a multiplayer gaming environment;

FIG. 2 is a schematic illustration of a multiplayer gaming data processing system configured for dynamic peer-to-peer map reconciliation; and,

FIG. 3 is a flow chart illustrating a process for dynamic peer-to-peer map reconciliation in a multiplayer gaming environment.

### DETAILED DESCRIPTION OF THE INVENTION

Embodiments of the invention provide for dynamic peer-to-peer map reconciliation in a multiplayer gaming environment. In accordance with an embodiment of the invention, individual maps for respectively different portions of a virtual world can be generated separately for individual game players in a multiplayer gaming environment responsive to the players moving about the virtual world of the multiplayer gaming environment. As a particular one of the players approaches a boundary in the virtual world between an individual map of the particular one of the players and an individual map of a peer one of the players, the boundary incorporating portions of both individual maps can be reconciled uniformly and presented as part of the individual maps of each of the players. In this way, dynamic map generation can be enabled without performance penalty through peer-to-peer map reconciliation.

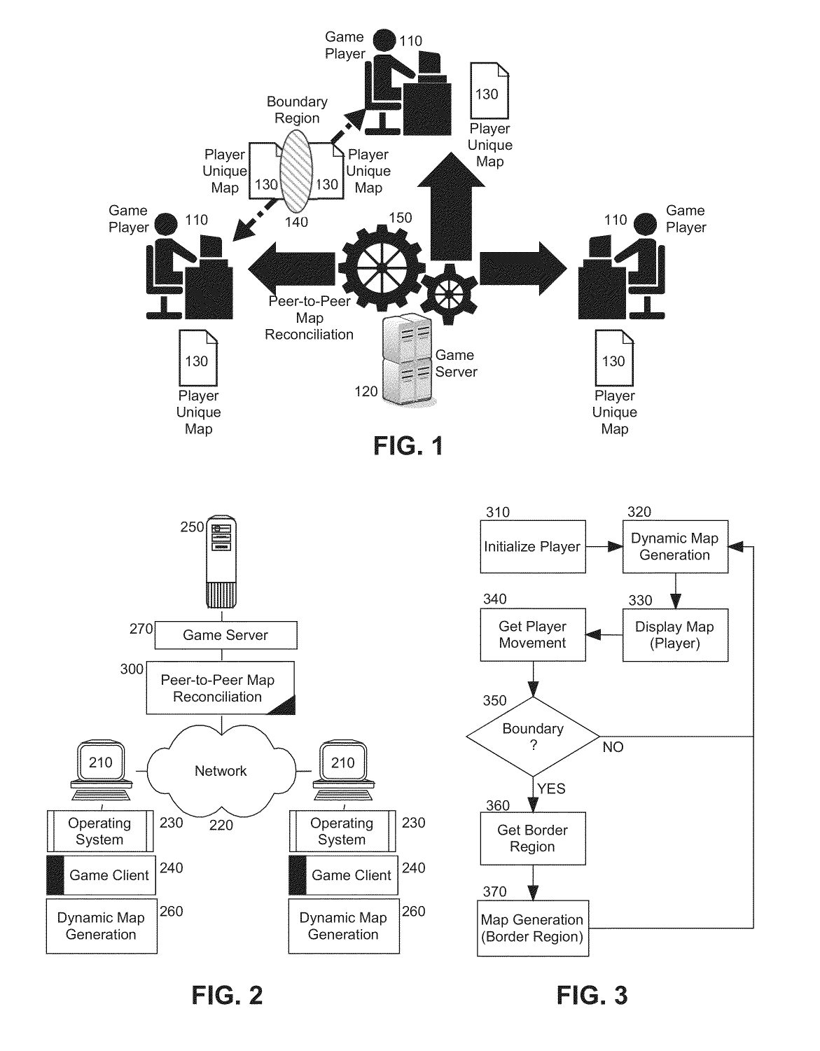

In further illustration, FIG. 1 pictorially shows a process for dynamic peer-to-peer map reconciliation in a multiplayer gaming environment. As shown in FIG. 1, different game players 110 can participate in a multiplayer game provided by a game server 120. A virtual world of the multiplayer game can be created based upon a composition of different dynamically generated player maps 130 generated dynamically for each of the game players 110. Each of the game players 110 can move about a corresponding one of the dynamically generated player maps 130, however, as one of the game players 110 approaches within a corresponding one of the dynamically generated player maps 130 a boundary region 140 of another of the dynamically generated player maps 130 corresponding to a different one of the game players 110, peer-to-peer map reconciliation logic 150 can coordinate the reconciliation of portions of both dynamically generated player maps 130 included within the boundary region 140.

In this regard, as a first game player 110 moves toward a boundary region 140 coupling a corresponding dynamically generated map 130 for the first game player 110 with a dynamically generated map 130 of second game player 110, the logic 150 can coordinate the retrieval of a portion of the dynamically generated player map 130 of the second game player 110 in the boundary region 140 for use by the first game player 110 in dynamically generating an intersecting portion of the dynamically generated player map 130 for the boundary region 140 for the first game player 110, including maintaining consistency in topography and/or structures of both dynamically generated maps 130. Conversely, as the second game player 110 moves toward the boundary region 140, the logic 150 can coordinate the retrieval of a portion of the dynamically generated player map 130 of the first game player 110 in the boundary region 140 for use by the second game player 110 in dynamically generating an intersecting portion of the dynamically generated player map 130 for the boundary region 140 for the second game player 110

The process described in connection with FIG. 1 can be implemented within a multiplayer gaming data processing system. In yet further illustration, FIG. 2 schematically shows a multiplayer gaming data processing system configured for dynamic peer-to-peer map reconciliation. The system can include a host computer 250 within which a game server 270 executes providing a virtual world of a multi-player gaming environment for the benefit of different game players. The different game players, in turn, access the multi-player gaming environment through respective game clients 240 hosted by corresponding operating systems 230 executing in the memory of respective client computers 210 communicatively coupled to the host computer 250 over computer communications network 220. Of note, each game client 240 can be coupled to a corresponding dynamic map generator 260 configured to dynamically generate a mapped portion of the virtual world proximate to the game player. As the game player traverses the virtual world, the dynamic map generator 260 can continuously generate new portions of the virtual world proximate to the game player.

Notably, a peer-to-peer map reconciliation module 300 can be coupled to the game server 270. The logic 300 can include program code enabled to detect when a game player managed by one game client 240 approaches a bordering dynamically generated map of another game player managed by another game client 240. In this circumstance, the program code of the logic 300 can facilitate the exchange of map information for a bordering region of the different dynamically generated maps such that the dynamic map generator 260 of each of the game clients 240 can coordinate the uniform generation of the bordering region. For instance, both dynamic map generators 260 can rely upon the map generation of the bordering region by a designated one of the dynamic map generators 260, with the designated one of the dynamic map generators 260 generating the bordering region and providing data representative of the bordering region to the other of the dynamic map generators 260 for use by a corresponding one of the game clients 240.

It is to be noted that that the peer-to-peer map reconciliation logic 300 can reside centrally in the game server 270, or the peer-to-peer map reconciliation logic 300 can be distributed in association with each game client 240. In either case, it remains the burden of the peer-to-peer map reconciliation logic 300 to reconcile bordering regions between different dynamically generated maps in the gaming environment produced by individual dynamic map generators 260 for the multi-player gaming environment provided by the game server 270. In yet further illustration of the operation of the FIG. 3 is a flow chart illustrating a process for dynamic peer-to-peer map reconciliation in a multiplayer gaming environment.

Beginning in block 310, a game player can be initialized for use in a virtual world of the multi-player gaming environment. In block 320, a map generation engine of the game player can generate a portion of a dynamically generated map consistent with a contemporaneous location of the game player in the virtual world. Thereafter, in block 330, the generated portion of the dynamically generated map can be displayed in a computer display of a host computer utilized by the game player. In block 340, player movement of the game player can be detected including a direction of movement and a contemporaneous position of the game player in the portion of the dynamically generated map. In decision block 350, it can be determined whether or not the player movement has resulted in the game player moving into proximity of a bordering map of another game player. If not, in block 320 a portion of a dynamically generated map can be dynamically generated for the game player consistent with the new location of the game player in the virtual world. The process can repeat then in block 330, with the portion of the dynamically generated map being displayed in the computer display.

In decision block 350, if it is determined that the player movement has resulted in the game player moving into proximity of a bordering map of another game player, in block 360 a border region between both maps can be determined and in block 370, the border region can be generated so as to harmonize the terrestrial and structural features of both maps. In this regard, the portion of the border region included as part of a map dynamically generated by the other game player can be retrieved from the other player. To the extent that the requisite portion has not yet been generated by a map generation engine of the player of the bordering map, the movement of the game player further toward the border region can be inhibited.

Once the requisite portion has been retrieved, the remaining portion of the border region can be generated in a manner consistent with the terrestrial and structural features of the requisite portion of the map of the other game player. For example, to the extent that a structure is present in the requisite portion of the border region of the map of the other game player, a view to the structure can be established in the remaining portion of the border region in a position of the remaining portion that is correspondent to the position of the terrestrial feature in the requisite portion. Likewise, to the extent that a terrestrial feature such as a tree, river or mountain is present in the requisite portion of the border region of the map of the other game player, a view to the terrestrial feature can be established in the remaining portion of the border region in a position in the remaining portion that is correspondent to the position of the terrestrial feature in the requisite portion.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radiofrequency, and the like, or any suitable combination of the foregoing. Computer program code for carrying out operations for aspects of the present invention may be written in any combination of one or more programming languages, including an object oriented programming language and conventional procedural programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems) and computer program products according to embodiments of the invention. In this regard, the flowchart and block diagrams in the Figures illustrate the architecture, functionality, and operation of possible implementations of systems, methods and computer program products according to various embodiments of the present invention. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A dynamic peer-to-peer map reconciliation method for multiplayer gaming, the method comprising:
generating a portion of a map in memory of a computer for a contemporaneous position of a first game player in a virtual world in a multiplayer gaming environment;
displaying the portion of the map in a display of the computer;
detecting movement of the first game player to a new position in the virtual world in proximity to a bordering map generated by a second game player in memory of a computer communicatively coupled to the computer of the first game player over a computer communications network; and,
generating and displaying in the computer of the first game player a new portion of the map for the new position of the first game player that is consistent with a portion of the bordering map in respect to both structure and terrain.

2. The method of claim 1, wherein the map for the new portion is generated by requesting from the second game player a portion of the bordering map at a border region between the map of the first game player and the bordering map of the second game player, receiving the requested portion and generating the new portion by including structural and terrestrial features of the retrieved portion in the new portion.

3. The method of claim 2, further comprising inhibiting further movement of the first game player towards the bordering map until the new requested portion is received from the computer of the second game player.

4. A multiplayer game data processing system comprising:
a computer with at least one processor and memory coupled to a host server over a computer communications network;
a game client executing in the computer and providing a user interface to a map of a virtual world provided by a game server hosted by the host server;
a map generator executing in the computer and generating a portion of the map according to a corresponding contemporaneous position of a game player in the virtual world; and,
a peer-to-peer map reconciliation module coupled to the map generator, the module comprising program code enabled to detect movement of the game player to a new position in the virtual world in proximity to a bordering map generated by a different game player and to generate a new portion of the map for the new position of the game player that is consistent with a portion of the bordering map in respect to both structure and terrain.

5. The system of claim 4, wherein the program code of the module executes in the host server.

6. The system of claim 4, wherein the program code of the module executes in the computer.

7. The system of claim 4, wherein the map for the new portion is generated by requesting from the different game player a portion of the bordering map at a border region between the map generated by the map generator and the bordering map of the different game player, receiving the requested portion and generating the new portion of the map by including structural and terrestrial features of the retrieved portion in the new portion.

8. The system of claim 5, wherein the program code of the module inhibits further movement of the game player towards the bordering map until the new requested portion is received.

9. A computer program product for dynamic peer-to-peer map reconciliation method for multiplayer gaming, the computer program product comprising:
a computer readable storage medium having computer readable program code embodied therewith, the computer readable program code comprising:
computer readable program code for generating a portion of a map in memory of a computer for a contemporaneous position of a first game player in a virtual world in a multiplayer gaming environment;
computer readable program code for displaying the portion of the map in a display of the computer;
computer readable program code for detecting movement of the first game player to a new position in the virtual world in proximity to a bordering map generated by a second game player in memory of a computer communicatively coupled to the computer of the first game player over a computer communications network; and,
computer readable program code for generating and displaying in the computer of the first game player a new portion of the map for the new position of the first game player that is consistent with a portion of the bordering map in respect to both structure and terrain.

11. The computer program product of claim 10, wherein the map for the new portion is generated by requesting from the second game player a portion of the bordering map at a border region between the map of the first game player and the bordering map of the second game player, receiving the requested portion and generating the new portion by including structural and terrestrial features of the retrieved portion in the new portion.

12. The computer program product of claim 11, further comprising computer readable program code for inhibiting further movement of the first game player towards the bordering map until the new requested portion is received from the computer of the second game player.
